(19) United States
(12) Patent Application Publication
(10) Pub. No.: US 2003/0233336 A1
(43) Pub. Date: Dec. 18, 2003

(54) System to retate personal information to a unique identifier

(75) Inventor: Kevin Clark, Chicago, IL (US)

Correspondence Address: Mr. Kevin W. Clark, c/o Objectsoft, Inc., 750 North Clark, Chicago, IL, 60610, US

(73) Assignee: Objectsoft, Inc., Chicago, IL

(21) Appl. No.: 10/167,976

(22) Filed: Jun. 13, 2002

(51) Int. Cl. G06F 7/00

(52) U.S. Cl. 707/1

(57) ABSTRACT

A method and apparatus to recognize an individual based on specific personal information and relate that individual to a unique identifier within a system. When communicating with the individual through email, voice or some other means, the system will match personal information to find the unique identifier. If no unique identifier is found, the system will dynamically create a unique identifier and save it with the personal information used for communication. Once established, the unique identifier will be used to maintain all data relationships between users and data in the system. Using the aforementioned capabilities, applications may interact with people not currently registered as users in the system. The invention allows anyone to become a user in the system while maintaining all data relationships.

### CROSS REFERENCE TO RELATED APPLICATIONS

This application claims priority based on U.S. Provisional Patent Application Serial No. 60/296,212, entitled “System to relate unique personal information to a unique identifier” filed Jun. 7, 2001

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF INVENTION

Various software and Internet services exist to facilitate communications and collaboration. Users are added to the system via a process of self-registration or by some administrator of the system. Users added to the system are ‘registered users.’ Users not added to the system that interact with the system are ‘unregistered users.’

Current systems do not recognize unregistered users unless the user is specifically added as defined above. An unregistered user may interact with a system and the history or data collected during interactions is not saved in a personal user profile. If the unregistered user has multiple interactions with the system, their information needs to be re-entered each time.

What is needed is a better means of organizing and restoring personal user profile information for an unregistered user. When a registered user in the system interacts with an unregistered user, it should utilize the existing information for the unregistered user. One example involves scheduling an event. Someone planning an event would like to invite other participants. Often, an electronic invitation is created and participants are notified via email. Participants often respond to the invitations. By keeping track of participants, their responses and their personal information, the system will allow existing users to interact with the same unregistered user regardless of how the personal information changes.

Basically a system is needed to unqiuely identify a user so all other users of the system are interacting with the same personal profile in the system. And, if the unregistered user decides to become a registered user, the personal information profile will be intact for them to update as necessary during the registration process.

A solution to this problem is to dynamically define users when the first interaction occurs. So, if system applications interact with someone that is not a registered user, the system will establish a new user profile for that person that is used in all future system interactions.

### SUMMARY OF INVENTION

The aforementioned limitations are evident in systems today that interact with potential users through the Internet. The invention introduces a system that dynamically builds a profile for users that have never been added or registered with the system.

The system assigns a unique identifier to each new user it encounters. By choosing a unique identifier, the system can allow the user to change personal information while the system maintains relationships to other users and data within the system.

The invention is best understood by those skilled in the art by reading the detailed description of the preferred embodiments in conjunction with the drawings that are first described briefly below.

### BRIEF DESCRIPTION OF DRAWINGS

FIG. 1A is a block diagram of a computer system in which the present invention may be embodied.

FIG. 1B is a detailed block diagram of the server architecture of the inventio.

FIG. 2A—is a flowchart of the identification and building of a unique profile view based on email or phone number search

FIG. 2B—is a fowchart of the security process to detemine how much infromation may be viewed by the source of a request.

FIG. 3—is a flowchart of the registration process for a new user.

FIG. 4 is a flowchart of the profile gathering process when interacting with user that may or may not be registered with the system.

FIG. 5 is a flowchart of a send email process and how it utilizies the system to locate the unqiue profile by email.

FIG. 6A is a flowchart of a scheduling process using email as a primary locator of the user profile.

FIG. 6B is a flowchart of the scheduling process receiving a completed event from a source outside the system.

FIG. 7 is a flowchart of the a phone call logging process.

FIG. 8 is a flowchart of a phonebook lookup process using profiles from other users in the system.

### DETAILED DESCRIPTION

The present invention is directed at providing a better process for relating a user profile in a computer system to unique indentifying information that may be entered into software applications and used to identify the unique profile. Breifly described, the program allows another user to enter a phone number, email or some other unique information about a person. If necessary, the program will locate a user profile to the program can relate actions in the system by a unique identifier that will not change.

For the purposes of this discussion, a profile is a user profile in the system and is controlled by the profile owner themselves. A contact is a not a profile. It is information entered by a user of the system. It contains similar information to a profile, but is entirely controlled by the user creating it. In contrast, a profile is controlled by the profiles owner.

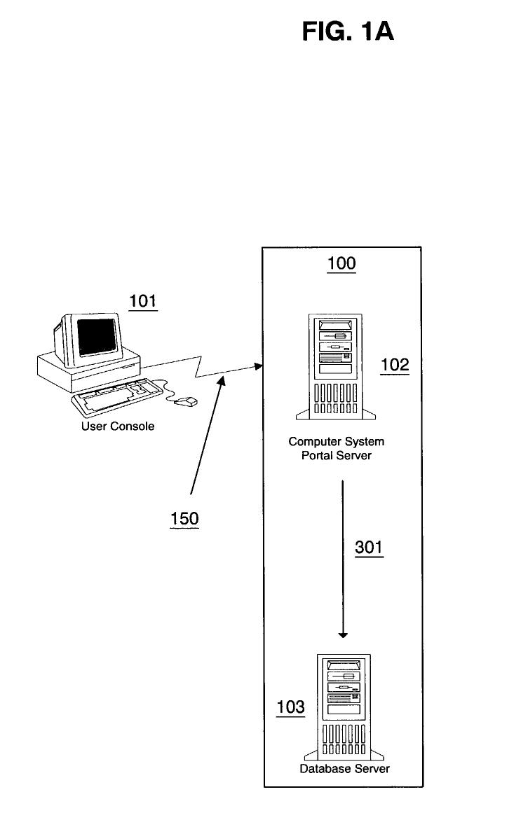

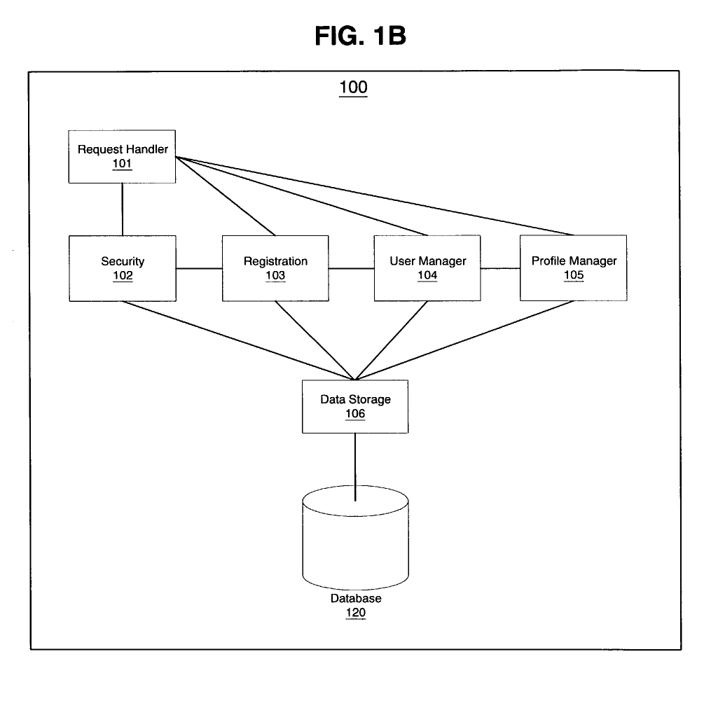

FIG. 1A and the following discussion are intended to provide an overview of the computing environment in which the invention may be implemented. While the program will be described in the general context of an application program that runs in an operating system in conjunction with personal computers, hand-held devices, and telephones, those skilled in the art will recognize that the invention also may be implemented in combination with other program modules. Generally, program modules include routines, programs, components, data structures, etc. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced utilizing standard telephone systems as a terminal to respond to and generate requests from the application program. The invention may also be practiced in distributed computing environments where tasks are performed by remote processing devices that are linked through a communications network. In a distributed environment, program modules may be located in both local and remote memory storage systems.

Referring now to the drawings wherein like reference numerals refer to like elements, FIG. 1A illustrates a portal system 100 which comprises a computer system acting as a portal server 102 and may include a database server 103. The user console 101 may be comprised computers, laptops, hand-held devices, PDAs, pagers, phones, etc. A user, acting as the initiator of an action, may utilize a computer 103 to generate some request to the portal server 102 which, in turn, attempts to match information from the request to a profile existing in the system or database 103.

And in FIG. 1A, the transport medium 150 preferably using Internet Protocols (IP). A client 200 can be any device that connects to the system 100 via the Internet or other transport methods that includes, but is not limited to, such devices as televisions, computers, hand-held electronic devices, wireless electronic devices, and in point of fact, any device that uses an electronic transport medium. Non-limiting examples of the transport medium 1 50 any backbone or link such as an ATM Link, FDDI Link, satellite link, cable, twisted pair, fiber-optic, broadcast wireless network, the Internet, Local Area Network (LAN), Wide Area Network (WAN), or any other kind of network environment such as a standard Ethernet link. In such alternative cases, the clients will communicate with the system using protocols appropriate for the network which that client is attached.

FIG. 1B is a functional block diagram of the software modules of the profile locator program 100 constructed in accordance with the exemplary embodiment of the present invention. The profile locator program 100 includes several major software modules: request handler 101, authentication/authorization 102, registration 103, user manager 104, profile manager 105, and data storage subsystem 106 used with a database 120. Each of these modules are discussed in detail below.

In FIG. 1B the request handler module 101 is the main module that receives a request with information to identify a user. The request sent to the profile manager module which will attempt to locate the matching profile in the database 120. If the profile is located, the request handler 101 will verify that the source of the request is allowed to view the profile information by checking with the security module 102. The security module 102 will determine the amount of information about the user profile the source of the request may view, if any.

Again in FIG. 1B, if the request is a registration request, the request handler 101 will forward the request to the registration module 103 which will guide the user through the registration process. The registration module 103 will utilize the user manager module 104 to create a new user to the system.

And in FIG. 1B, if the request is a login request, the request handler will check with the security module 102 to see if the login is valid. If valid the request handler will fetch the user profile from the profile manager module 105.

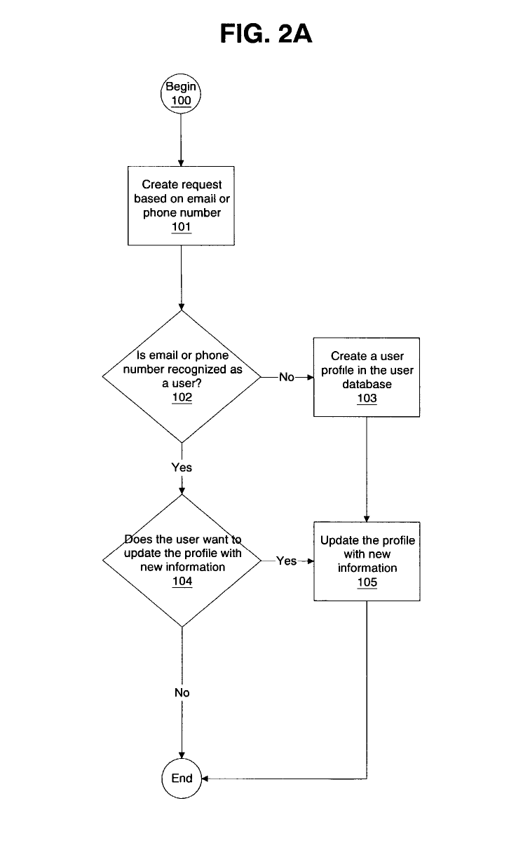

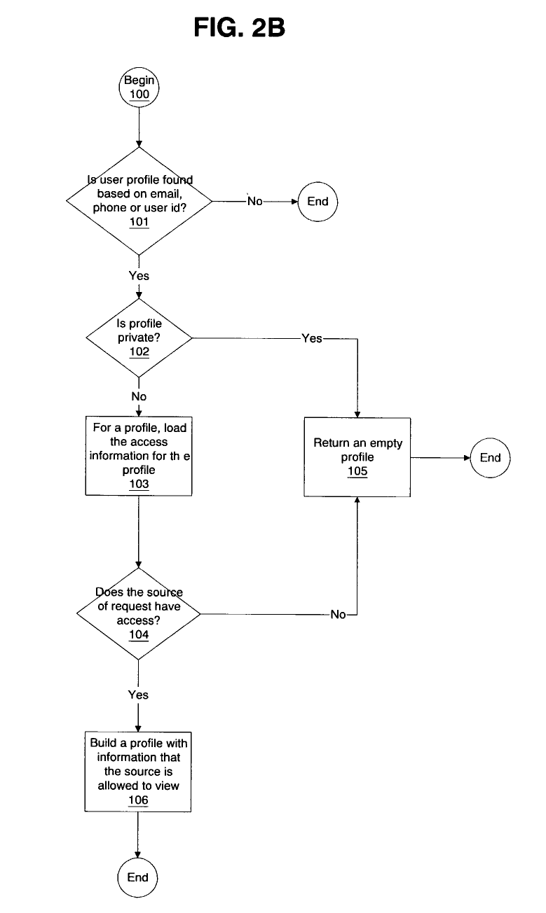

In FIG. 2A a program may invoke a request that is directed at a person identified by email or phone number 101. This is the person receiving the request. This person may be presented with some interface that may gather information needed for the program that may include profile information such as email, phone numbers or addresses. If the information gathered contains standard profile information and the program can locate the profile based email or phone number gathered from the user 102, it may ask the user if they wish to update their profile 104. If the user choses to update their profile, the program may save the new profile information 105. If the user does not want to update their profile, the process ends. If the program cannot find the profile based on email or phone number 102, it may automatically create a profile based on email or phone number 103 and save whatever profile information is available 105 and the process terminates.

In FIG. 2B a program may request profile information from the profile manager module 105 in FIG. 1B. The request may contain email, phone number or unique id to locate the user profile. If the user profile is found 101, then the program may determine if it is private 102. If it is not private the program may utilize the security module 102 in FIG. 1B and load the access information for the profile for source of the request 103. If the source of the request may view the profile found 104 the program may build a profile with the information the source of the request is allowed to view 106. If the profile is private or the source request does not have access permissions to view the profile, an empty profile may be returned 105.

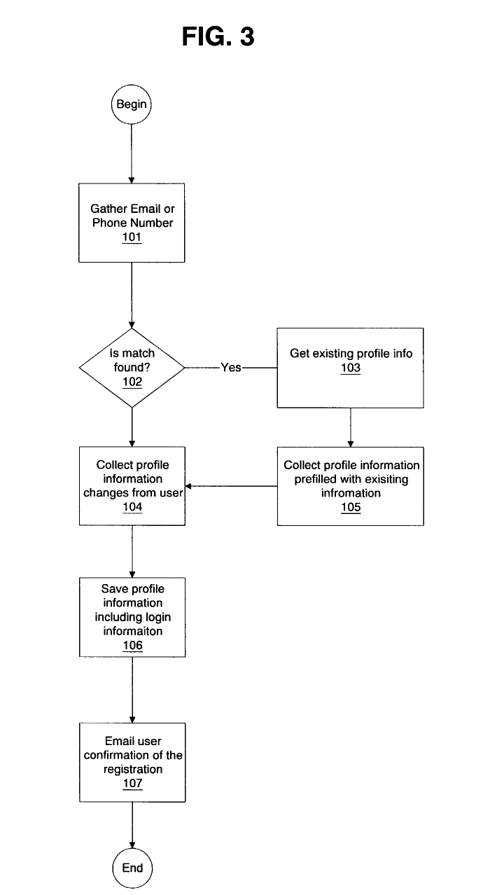

FIG. 3 the user may choose to register with the system. In this process, the program collects email or and/a phone number 101 and checks the user profile database for a match 102. If a match is found, the system may fetch the existing profile information 103 and pre-fills a form to collect additional profile information 105. After the user edits the profile information 104 they may choose to save the information an 106. Saving the profile information with login information may register the user profile as active on the system. The registration module 103 in FIG. 1B may send a confirmation to the user that they are registered 107.

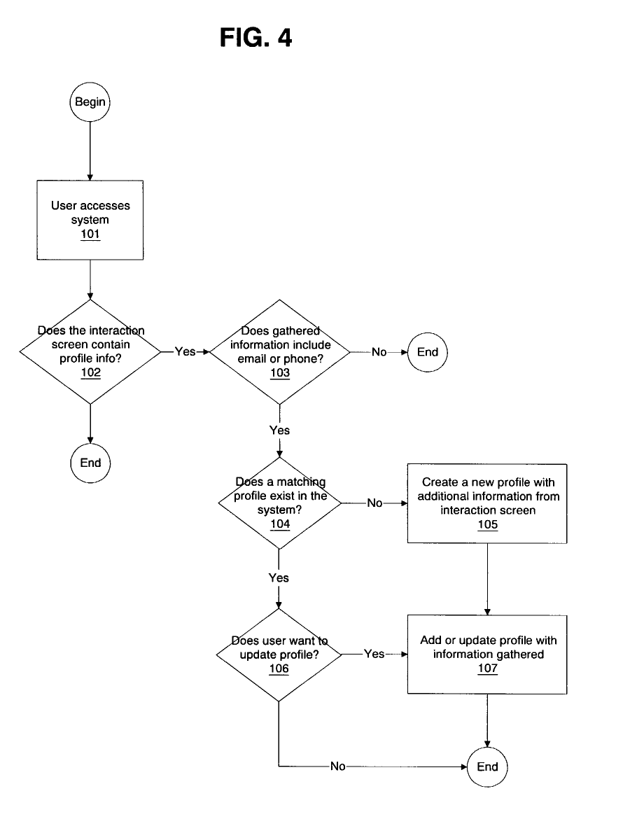

FIG. 4 is a workflow of the process of update profiles when users interact with the program containing information that is related to their exisiting profile. First the user must interact with some portion of the system by accessing the program 101. If the interaction happens to collect profile related information 102 such as a home address, then the program may also check if the information includes a email or phone number 103 so it has a means to locate profile information. If there is an email or phone number present, the program may attempt to locate the matching user profile 104. If a profile is not located, the program may dynamically create a user profile 105 with all information it currently has available. If a profile is located 104, the program may ask the current user 106 if they wish to update their profile with the new information entered. All profile creations or updates are saved 107 in the database 120 in FIG. 1 B.

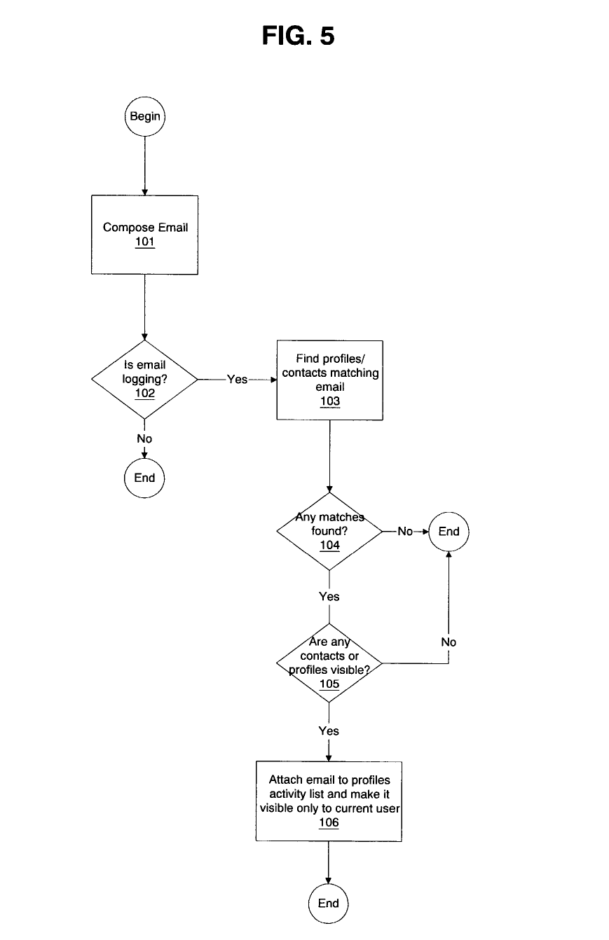

FIG. 5 is a workflow of the process of sending an email and attaching the email to a profile if found within the system. First, the current user may compose an email 101. If the current user chooses to log the email 102, then after the email is sent the program will locate all contacts and profiles visible to the current user that match the receipients of the emails 103. If the matches of contacts or profiles that are visible to the current user 105 are found and the logging option is on, then the program will attach the email to the contacts and profiles activity list 106 with a relationship to the current user. Therefore, other users of the program will not be able to view the attached emails on the contacts and profiles.

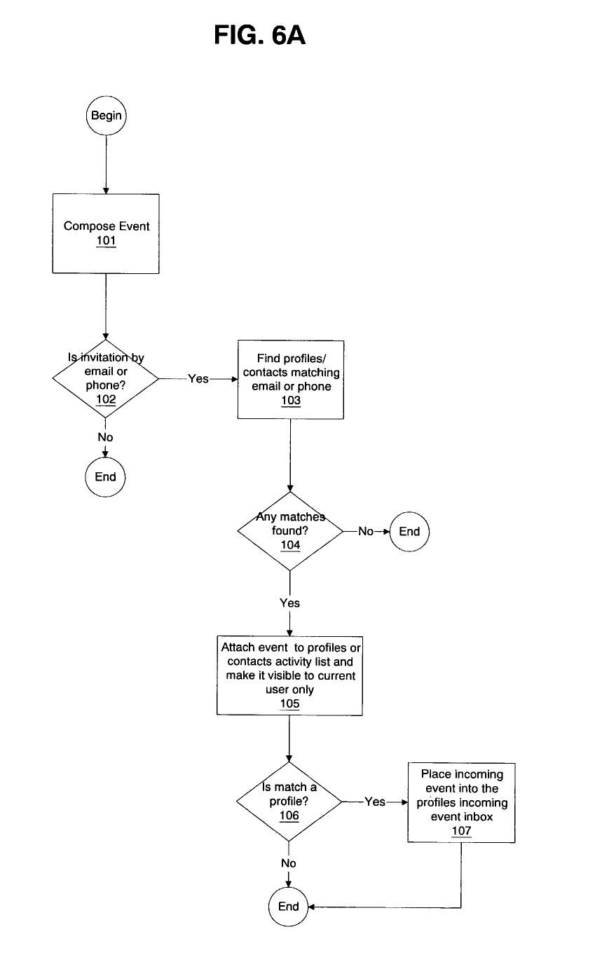

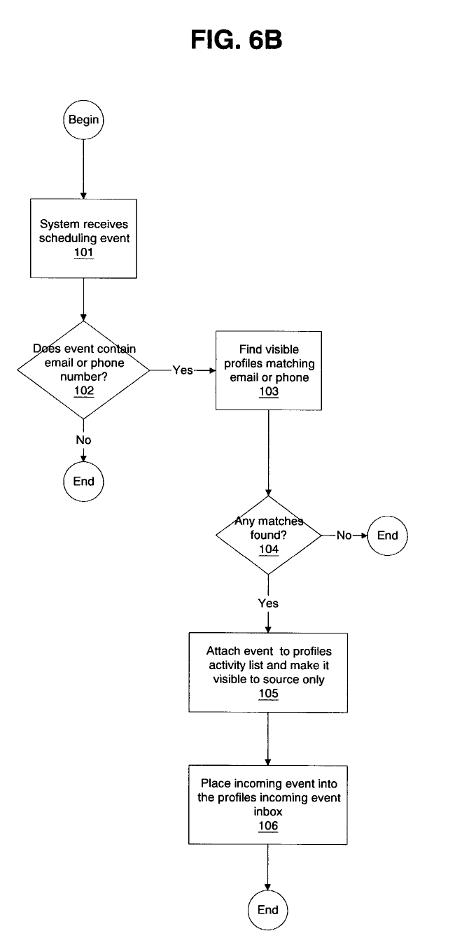

FIG. 6A is a scheduling event workflow using email as a primary profile locator. The current user will compose a scheduling event 101. If the event includes invitations based on email or phone number 102, the program will locate contacts and profiles visible to the current user that match the email or phone number entered 103. If matches are found 104, the program will attach the new event to the profiles or contacts activity list 105. If match is a profile 106, the invitation to the event may be placed in the profiles inbound event box 107.

FIG. 6B is a workflow that occurs when the program receives a scheduling event and attaches it to the correct profile. When the program receives a scheduling event from a known source 101, it will check to see if the event has an email or phone number 102. If it does not, the process ends. Otherwise, the program may locate profiles visible to the source that match the email or phone number on the event 103. If no matches are found 104, the process ends. If matches are found 104, the system will attach the event to the profiles activity log so it is visible only to the source that sent the event 105. The program will then place the event in the inbox event box of the profile 106.

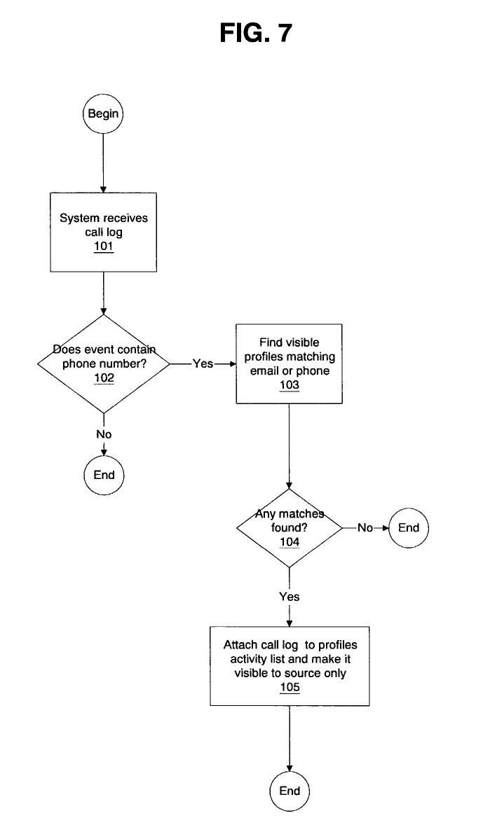

FIG. 7 is a workflow that occurs when the program receives a call log and attaches it to the correct profile. When the system receives a scheduling event from a known source 101, it will check to see if the call log has an phone number 102. If it does not, the process ends. Otherwise, the program may locate profiles visible to the source that match the phone number on the call log 103. If no matches are found 104, the process ends. If matches are found 104, the program may attach the call log to the profiles activity log so it is visible only to the source that sent the call log 105.

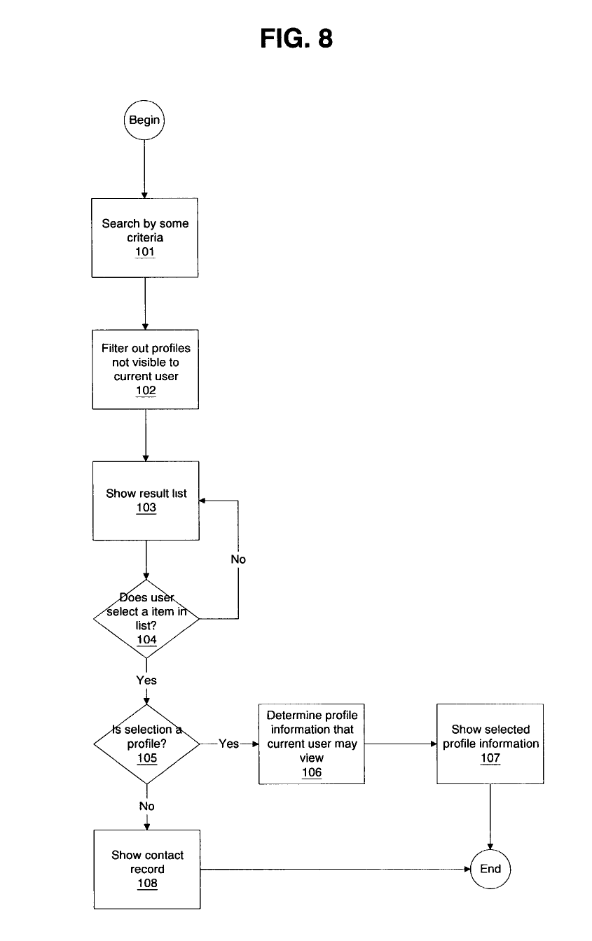

FIG. 8 is a workflow of a phonebook lookup process for a user of the system. While other phonebook systems rely on the user to enter and control all information in the phonebook, the proposed embodiment of this invention may find matching records of other users in the system that have granted profile view capabilities to the current user. In this workflow, the current user searches based on some criteria 101, such as name, address, city, etc. The program will search contacts and profiles visible to the current user filtering out all information not visible 102. The results are shown in a listing 103. The current user may select one of the elements in the list for a detailed view 104. If the selection is a contact 105, the user will see all information about that contact 108 since they are the creator and owner of the data. If the selection is a profile 105, the program will determine the information that is visible to the current user 106 and display only the visible information 107. The profile owner controls the information they wish to make visible to others.

1. A system for creating user profiles with user information that may include name, addresses, emails, phone numbers, notes, birthdays, important events and calendar information.

2. A system of claim 1 that has a means to store user profiles related to a unqiue identifier.

3. A system of claim 2 that has
a means to relate one to many email addresses to a user profile;
a means to relate one to many phone numbers to a user profile.

4. A system of claim 3 that stores a private indicator to make a profile unaccessible to other users in the system.

5. A system of claim 4 that stores a enabled indicator to determine if the user can access the system.

6. A system of claim 5 further comprising a means to lookup a user profile based on email address or phone number.

7. A system of claim 5 that can dynamically create a unique identifier when a user profile cannot be located by email address, phone number or unique identifier.

8. A system of claim 5 that may support grouping of users.

9. A system of claim 8 that may support users belonging to multiple groups.

10. A system of claim 8 that may support removal of users from groups.

11. A system of claim 8 that may allow users to self register and updates the unique user profile in system with the new information gathered during registration.

12. A system of claim 5 that may allow users to correct their own profile information in the system.

13. A system of claim 5 that may automatically fetch a user profile based on email or phone number when those data elements are used to identify a person or user.

14. A system of claim 13 that may only locate profiles if the current user has been granted access to the profile by the profile owner.

15. A system of claim 13 that may locate a profile by email and optionally attach email to the profile when using an email application.

16. A system of claim 13 that may locate a unique profile in the system and store an event related to that profile when scheduling an event utilizing email or phone number to identify invited participants.

17. A system of claim 13 that may locate a unique profile in the system and store an event related to that profile when a schedule event is received by the system.

18. A system of claim 13 that may locate a unique profile in the system and store a call log related to that profile when a call log is received by the system.

19. A phonebook program utilizing the system of claim 13 consisting of shared user profiles in the system where access rights are determined by the owner of each profile.
